(19) United States
(12) Patent Application Publication
(10) Pub. No.: US 2010/0125580 A1
(43) Pub. Date: May 20, 2010

(54) AUTOMATIC BUDDY MANAGEMENT

(76) Inventors: Peter T. Westen, Mountain View, CA (US); Justin Wood, Sunnyvale, CA (US); Pierre de Filippis, Cupertino, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/264,900

(22) Filed: Nov. 4, 2008

(51) Int. Cl. G06F 7/06; G06F 7/00; G06F 17/30

(52) U.S. Cl. 707/737

(57) ABSTRACT

Exemplary embodiments of methods and apparatuses to provide automatic buddy management are described. One or more tags associated with a user on an instant messaging (IM) network are determined. One or more groups are organized based on the one or more tags associated with the user. The one or more tags associated with the user are communicated to the IM network. The one or more groups associated with the user may be displayed on a display. One or more tags associated with one or more other users on the IM network may be received. The one or more other users may be included into the one or more groups. One or more new groups may be created based on the one or more tags associated with one or more other users.

### FIELD OF THE INVENTION

At least some embodiments of the present invention relate generally to real-time communication over a network, and more particularly, to instant messaging.

### BACKGROUND

Typically, instant messaging (“IM”) refers to a form of real-time communication between two or more people based on typed text. The text may be conveyed via computers or other data processing systems connected over a communication network, for example, the Internet, Local Area Network (“LAN”), Wide-Area Network (“WAN”), peer to peer (“P2P”) computer network, and other communication networks.

The term “chat” may generally refer to a synchronous conferencing, asynchronous conferencing, or both. The term “chat” may thus mean any technology ranging from real-time online chat over instant messaging and online forums to fully immersive graphical social environments (e.g., virtual reality environments). IM and chat are technologies that create the possibility of a real-time communication between two or more participants over a network.

AOL Instant Messenger (AIM) released by AOL is an instant messaging and presence computer system that allows registered users to communicate in real time. AIM may provide a networking protocol that creates and manages the communications over a network. Typically, in AIM the information about buddies and a buddy list may be managed by a server to which the users connect to.

A P2P computer network typically uses diverse connectivity between participants in a network and the cumulative bandwidth of network participants rather than conventional centralized resources where a relatively low number of servers provide the core value to a service or application. P2P networks are typically used for connecting nodes via largely ad hoc connections. Such networks may be useful, for example, for sharing content files and real time information containing digital data, audio, video, and other types of information. An IM network may be a decentralized communication network that does not have a central authoritative server.

Bonjour software is Apple Inc.'s implementation of the Zero Configuration Networking Standard, a service discovery protocol. Bonjour may locate devices, e.g., printers, other computers, and the services that those devices offer on a local network using multicast Domain Name System service records. The software is typically included into Apple's Mac OS X. Bonjour for Windows typically includes a System Service that helps applications discover shared services on the local network, printer discovery wizard, and a plug-in for discovering local Web servers.

iChat is an instant messaging program produced by Apple Inc. Using a Jabber-like protocol and Bonjour for user discovery, iChat also allows for LAN communication. iChat may provide peer-to-peer instant messaging of users in an area recognized by Bonjour and does not involve a server.

With current IM tools, an IM user of the IM network may categorize his buddies according the IM user's own settings. The IM user generally creates and controls a buddy list. The user may add and/or remove a selected buddy to/from a group according to the user's individual settings. The user, however, does not have control over what groups he appears in other users buddy lists.

With email tools, groups may be created by having a name for a set of email addresses. The email is then sent to all people in the group.

A list of users on the IN network may be fluid. For example, the users may move, leave the area, change their names, come back to the area, connect to and/or disconnect from the network, turn on/off their computers, and so on. There may be no consistent identification of the users in the IN network. Every time when a user signs in to the IN network, the user has the ID based on his address on the network. The user's ID may be changed depending on his current address on the network. Current instant messaging tools do not have a way to organize the IM users to keep track of them reliably.

### SUMMARY OF THE DESCRIPTION

Exemplary embodiments of methods and apparatuses to provide automatic buddy management are described. One or more tags associated with a user on an instant messaging (IM) network may be determined. One or more groups of buddies are automatically organized based on the one or more tags.

In at least some embodiments, the one or more tags are assigned to the user. One or more groups are created based on the one or more tags. The user may be included into the one or more groups based on the one or more tags.

In at least some embodiments, the one or more tags associated with the user are communicated to the IM network. The one or more groups associated with the user may be displayed on a display.

In at least some embodiments, one or more tags associated with one or more other users on the IM network may be received by a user. The one or more other users may be included into the one or more groups associated with the user. One or more new groups may be created based on the one or more tags associated with the one or more other users.

In at least some embodiments, one or more tags associated with a user on an instant messaging network are received. Determination may be made whether the received one or more tags is similar to an existing tag. Determination may be made whether the received one or more tags needs to be filtered. One or more groups may be organized automatically based on the one or more tags.

In at least some embodiments, a first set of tags associated with a first identity of a user is communicated to an instant messaging (IM) network. A first set of groups may be organized based on the first set of tags. Further, a selection of a second identity of the user may be received. A second set of tags associated with the second identity of the user may be communicated to the IM network in response to the selection. In one embodiment, the user may be removed from one or more groups associated with the first set of tags, while the second set of tags associated with the second identity of the user is communicated to the IM network. A second set of groups may be organized based on the second set of tags. The second set of groups may be displayed on a display.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows an example of a data processing system that may be used in at least some embodiments of the present invention.

FIG. 2 shows one embodiment of an IM network communication system to provide automatic buddy management.

FIG. 3 shows a flowchart of one embodiment of a method to provide automatic buddy management.

FIG. 4 is a flowchart of one embodiment of a method to organize groups based on tags.

FIG. 5A illustrates one embodiment of a data structure that may underline a user interface having buddy groups organized based on tags.

FIG. 5B illustrates one embodiment of a user interface having buddy groups organized based on tags.

FIG. 5C illustrates one embodiment of a user interface to assign tags.

FIG. 6 is a flowchart of one embodiment of a method to organize groupings.

FIG. 7 is a flowchart of another embodiment of a method to automatically organize buddy groups based on tags.

FIG. 8 is a flow chart of another embodiment a method to organize groups based on a user identity.

### DETAILED DESCRIPTION

Exemplary embodiments of methods and apparatuses to provide automatic management of buddies are described. Typically, a chat refers to a text, audio, video communication between users on an IM network. Management of buddies may include automatically grouping of buddies in a buddy list to provide the chat on the IM network. One or more tags associated with a user on an instant messaging (IM) network are determined. The one or more tags associated with the user are communicated to the IM network. One or more groups are organized based on the one or more tags associated with the user. More specifically, users on the IM network may “tag” themselves with one or more labels (“tags”). The tag is an attribute of a user that the user may publish. The presence information including tags created by the user may be communicated to other users.

Bonjour uses Jabber/Extensible Messaging and Presence Protocol (XMPP) or XMPP similar notation language. XMPP is an open, XML-inspired protocol for near-real-time, extensible instant messaging (IM) and presence information (e.g., buddy lists). The presence information (e.g., a presence node) may be sent out to other users on the IM network.

In one embodiment, the presence information includes tags created by the user. In one embodiment, the tags represent groups the user wishes to be associated with in the IM network. In one embodiment, the presence information including a user name, a current status of the user (e.g., “available”, “on-line”) and one or more tags is sent to the users on the IM network. The users in the IM network then can have automatically organized groups in their user lists based on the presence information to determine who is available in the network to start a chat with, as described in further detail below. In one embodiment, Bonjour using Extensible Messaging and Presence Protocol (XMPP) is used for sending presence information that includes tags created by a user's CPU. An automatic buddy management, as described herein, can be used within an AOL's AIM network, Bonjour IM network, and any other IM network.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk, including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of media.

The algorithms and displays presented herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

At least certain embodiments of the inventions may be part of a digital media device, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in one embodiment, include a display device which is coupled to the media processing system to display titles or other indicators of media being selected through the input device and being presented, either through a speaker or earphone(s), or on the display device, or on both display device and a speaker or earphone(s).

Embodiments of the inventions described herein may be part of other types of data processing systems, such as, for example, entertainment systems or personal digital assistants (PDAs), or general purpose computer systems, or special purpose computer systems, or an embedded device within another device, or cellular telephones which do not include media players, or devices which combine aspects or functions of these devices (e.g., a media player, such as an iPod®, combined with a PDA, an entertainment system, and a cellular telephone in one portable device), or devices or consumer electronic products which include a multi-touch input device such as a multi-touch handheld device or a cell phone with a multi-touch input device.

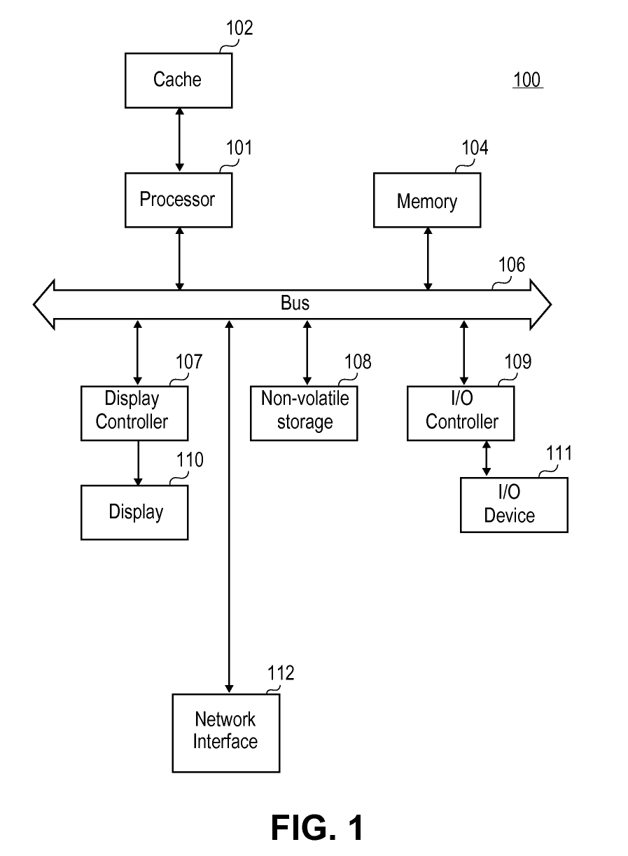

FIG. 1 shows an example of a data processing system that may be used in at least some embodiments of the present invention. Data processing system 100 may include a processor 101 (e.g., a microprocessor), and a memory 104 (e.g., a storage device), which are coupled to each other through a bus 106. In at least some embodiments, processor 101 can be a microprocessor, such as an Intel Pentium® microprocessor, Motorola Power PC® microprocessor, Intel Core™ Duo processor, AMD Athlon™ processor, AMD Turion™ processor, AMD Sempron™ processor, and any other microprocessor. In at least some embodiments, processor 101 can be a CPU, a microcontroller, a digital signal processor, a microprocessor, a personal computer (“PC”), or any combination thereof. In at least some embodiments, processor 101 can include a general purpose computer system based on the PowerPC®, Intel Core™ Duo, AMD Athlon™, AMD Turion™ processor, AMD Sempron™, HP Pavilion™ PC, HP Compaq™ PC, and any other processor families. Memory 104 can be dynamic random access memory (DRAM) and can also include static RAM (SRAM).

Bus 106 may include one or more buses connected to each other through various bridges, controllers, and/or adapters as is well known in the art. In at least some embodiments, bus 106 can be Peripheral Component Interconnect (“PCI”) bus, PCI-X, PCI Express, Universal Serial Bus (“USB”), IEEE 1394 bus (e.g., Firewire®), or any other bus known to one of ordinary skill in the art.

The bus 106 may couple the processor 101 also to non-volatile storage 108 and to display controller 107 and to the input/output (I/O) controller 109. One or more input/output controllers 109 are also coupled to bus 106 to provide an interface for input/output devices 111. The non-volatile storage 108 is often a magnetic hard disk, an optical disk, or another form of storage for large amounts of data. Some of this data is often written, by a direct memory access process, into memory 104 during execution of software in the data processing system 100. One of skill in the art will immediately recognize that the terms “computer-readable medium” and “machine-readable medium” include any type of storage device that is accessible by the processor 101 and also encompass a carrier wave that encodes a data signal.

The display controller 107 controls in a conventional manner a display on a display device 110 which can be e.g., a cathode ray tube (CRT), a liquid crystal display (LCD), and the like. The input/output devices 111 may include a keypad or keyboard, a cursor control device such as a touch input panel, mouse, speakers, microphone, printers, disk drives, a scanner, and other input and output devices. The display controller 107 and the I/O controller 109 can be implemented with conventional well known technology.

The data processing system 100 may optionally include a cache 102 which is coupled to the processor 101. A network interface 112 may be coupled to processor 101 via bus 106. Network interface 112 can be an analog modem, ISDN modem, cable modem, token ring interface, satellite transmission interface, or other interfaces for coupling a computer system to other computer systems. Network interface 112 may provide a wired network connection, wireless network connection (e.g. an RF transceiver), or both.

In at least certain embodiments, processor 101 may determine one or more tags associated with a user on an IM network and may automatically organize one or more groups based on the one or more tags, as described below. For example, the data may be analyzed through an artificial intelligence process or in the other ways described herein. As a result of that analysis, the processor 101 may then (automatically in some cases) cause an adjustment in one or more settings of the data processing system. The term “automatically” may describe a cause and effect relationship, such as where something is altered, changed, or set without receiving a user input or action directed at the altered or changed result. In some cases, the term “automatically” may describe a result that is a secondary result or in addition to a primary result according to a received user setting or selection. Data processing system 100 may be a laptop or otherwise portable computer, such as a handheld general purpose computer, a cellular telephone, and a desktop computer.

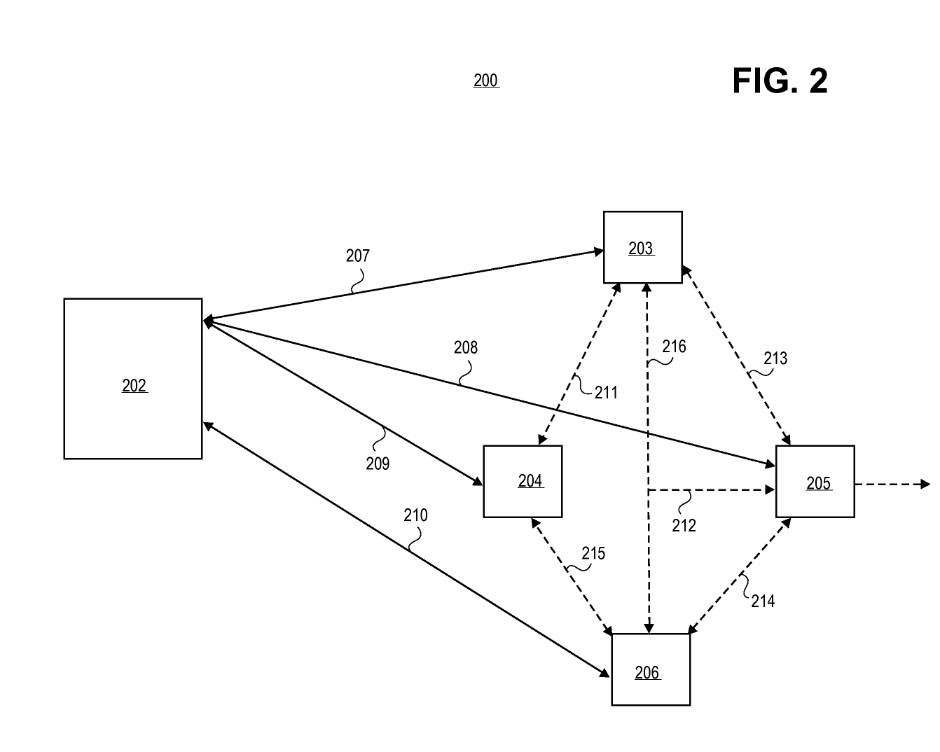

FIG. 2 shows one embodiment of an IM network communication system 200 to provide automatic buddy management. As shown in FIG. 2, system 200 may include a plurality of client devices (“users”) 202-206. The users may communicate (207-216) with each other in near real time using, for example, text, voice, and/or video. A list of users on IM network 200 is fluid. The users may leave and/or join IM network 200 at any time. For example, user 202 may join IM network, and user 205 may leave IM network, as shown in FIG. 2.

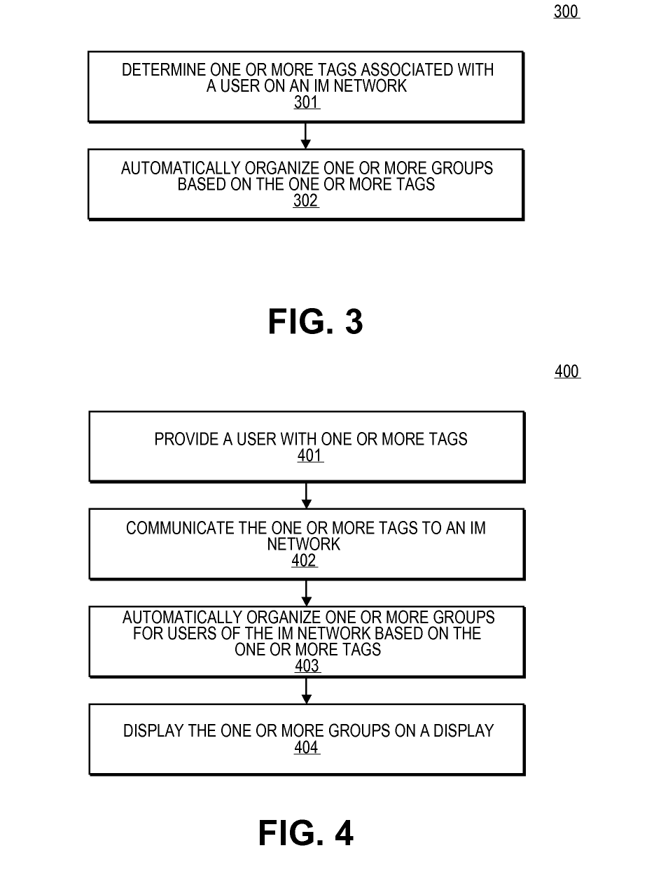

FIG. 3 shows a flowchart of one embodiment of a method to provide automatic buddy management. Method 300 begins with operation 301 that involves determining one or more tags associated with a user on an IM network. In one embodiment, determining includes assigning one or more first tags to the user based on user's own setting.

Referring back to FIG. 2, each of users 202-206 may categorize himself with one or more labels (“tags”). For example, user 202 may tag himself as “iChat” and/or “Commuter”. In one embodiment, the tags may be determined based on email groups the user wants to be in, based on web categories (e.g., Amazon, Google, iTunes, etc.).

The tags may be associated with groups on the IM network 200 that user 202 wants to be in. That is, the user controls over what groups of people in the IM network he appears in other users buddy lists. The tags provide a user with a consistent identity on the IM network.

Referring back to FIG. 3, method 300 continues with operation 302 that involves automatically organizing one or more groups based on the one or more tags. In one embodiment, organizing the groups involves creating the groups based on the tags. The groups are identified by tags. In one embodiment, when a user appears on the IM network, the user publishes groups that he is (and/or want to be) a part of by using tags. In one embodiment, the tags are communicated (e.g., broadcasted) from the user to other users of the IM network. For example, when user 202 logs-in to the IM network, the tags associated with user 202 are communicated 207-209 to other users 203-206, and tags associated with other users 203-206 are communicated 207-209 to user 203.

In one embodiment, organizing involves including the user into one or more existing groups. For example, the user, e.g., user 202 may receive tags from other users, e.g., users 203-206. The user may include the other users, such as users 203-207 into the existing groups if the received tags are similar to the existing tags. The user may create new groups based on the received tags if the received tags are not similar to the existing tags, as described in further detail below.

Further, after receiving the tags from user 202, other users 203-206 can then automatically organize groups in their user (“buddy”) lists based on the tags of user 202. Any of users 203-206 that has user 202 as a buddy can then include user 202 in automatically created groups based the tags of user 202. These groups may also include other buddies that chose the same tags as user 202. Users 203-206 may receive 207-210 one or more tags from user 202, and user 202 may be included into existing groups if the tags of user 202 are similar to the existing tags, and new groups may be created based on the tags of user 202 if these tags are not similar to the existing tags, as described in further detail below. After automatically organizing the groups based on the tags, a user can choose any of the other users in the group to start an instant message session with. In one embodiment, a chat room may be started and/or joined by a user. The chat room may include all the people in the group. For example, if a user tags himself to be in a iChat group, the user can join the iChat chat room that all the people in that group or other groups can join to further bring together people with a common tag. This may be extremely useful, for example, in a university library setting. People working on the same exam, homework, material etc. may tag themselves as such and join a virtual study group of people working on the same thing. The first person to join may create the chatroom, the last person to leave may close the chat room.

FIG. 4 is a flowchart of one embodiment of a method 400 to organize groups based on tags. At operation 401, one or more tags are provided to a user according to user's own settings, as set forth above. At operation 402, one or more tags are communicated to other users in an IM network, as set forth above. At operation 403 one or more groups are automatically organized for users of the IM network based on the one or more tags, as set forth above. At operation 404, the one or more groups are displayed on a display.

Generally, when a user goes to an unfamiliar area, e.g., a public library, coffee shop, the user does not know the people in the area. With the embodiments of the invention, the people in the area can automatically identify themselves for the user when the user joins the IM network. The people may appear on the user's display with a name they've described themselves. This name can be their actual name, made up name, and/or anything else that identifies the people. In addition, the people can automatically identify themselves for the user by appearing on the user's display in groups organized based on the tags. The tags can provide a context of what these people actually are, and/or what they may help you with, and the like.

More specifically, for example, when a user goes to an area, e.g., a public library, and joins an IM network, groups of people automatically organized based on the tags are displayed, so that the user is given additional information about other users in the IM network. For example, the other users 203-206 identified themselves with tags are presented on the display of user 202 in groups, so that user 202 can recognize that users 203-204, e.g., are librarians, and users 205-206 belong to a study group by their tags. Typically, with an ad hoc group a user does not recognize everybody in the IM network. With a buddy list having groups automatically organized based on the tags the user can recognize everybody in the IM network based on everybody's own definition.

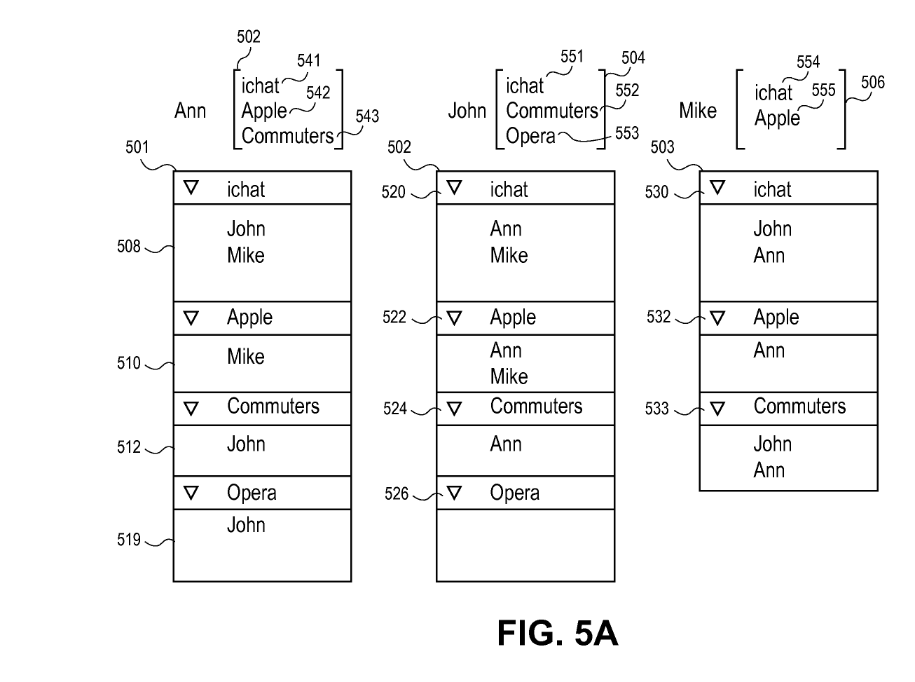

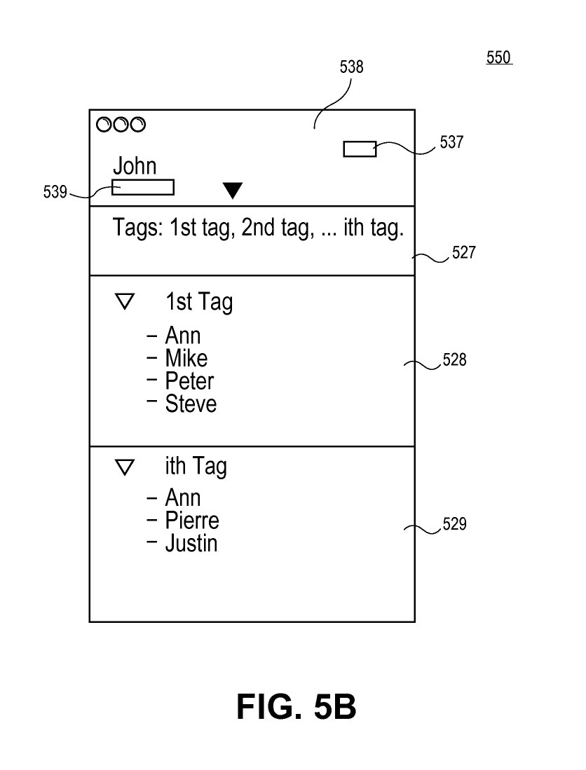

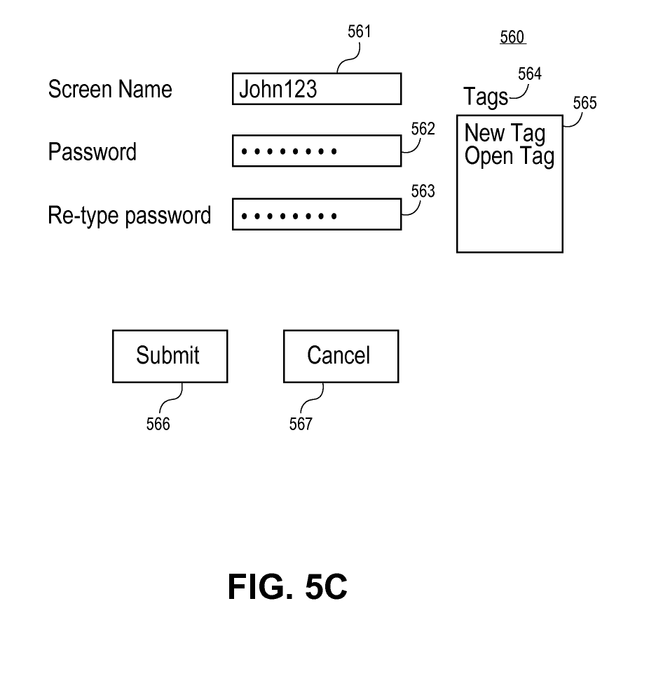

FIG. 5A illustrates one embodiment of a data structure that may underline a user interface having buddy groups organized based on tags. As shown in FIG. 5A, three persons, such as Ann, John, and Mike set various tags on themselves, so that each tag for a person defines what group in everybody else's list they may appear in without necessarily launching a chat with the group.

The users may tag themselves with the tags that correspond to the buddy groups that already exist in the IM network (e.g., published groups). The users may create a new tag and tag themselves with the new tags to create a new buddy group. As shown in FIG. 5A, Ann set herself with a set of tags 502, such as “iChat” 541, “Apple” 542, and “Commuters” 543; John set himself with a set of tags 504, such as “iChat” 551, “Commuters” 552, and “Opera” 553; and Mike set himself with a set of tags 506, such as “iChat” 554 and “Apple” 555.

As shown in FIG. 5A, Ann's group display 501 may present “iChat” group 508 having Mike and John; “Apple” group 510 having Mike, “Commuters” group 512 having John, and “Opera” group 514 having John. John's group display 502 may present “iChat” group 508 having Ann and Mike, “Apple” group 522 having Ann and Mike, “Commuters” group 524 having Ann, and “Opera” group 526 that does not have anyone. Mike's group display 503 may present “iChat” group 530 having John and Ann, “Apple” group 532 having Ann, and “Commuters” group 524 having John and Ann. The opera group shown on Ann's and John's displays 501 and 501 may be filtered out and not displayed on Mike's display 503, as shown in FIG. 5A. In one embodiment, a Boolean logic (“iChat” AND “Apple”) is used to decide in which groups to place the user (e.g., Mike) on other users' (e.g., Ann's and John's) displays.

A user can control his presentation in the groups in the buddy's lists on other user's displays. In one embodiment, when a user removes his tag, the user disappears from the respective group on other users' displays. For example, when Ann removes her “Commuters” tag 543, she disappears from the “Commuters” groups 524 and 533 on John's and Mike's displays respectively. The user cannot control presentation of other users in the groups in the buddy lists. For example, Ann cannot remove John from “Commuters” group 512 on her display 501. That is, a portion of the user interface that presents the user's tags, such as tags 502, is determined by the user's own settings. The portion of the user interface that presents groups, such as group display 501, is determined by other users' settings.

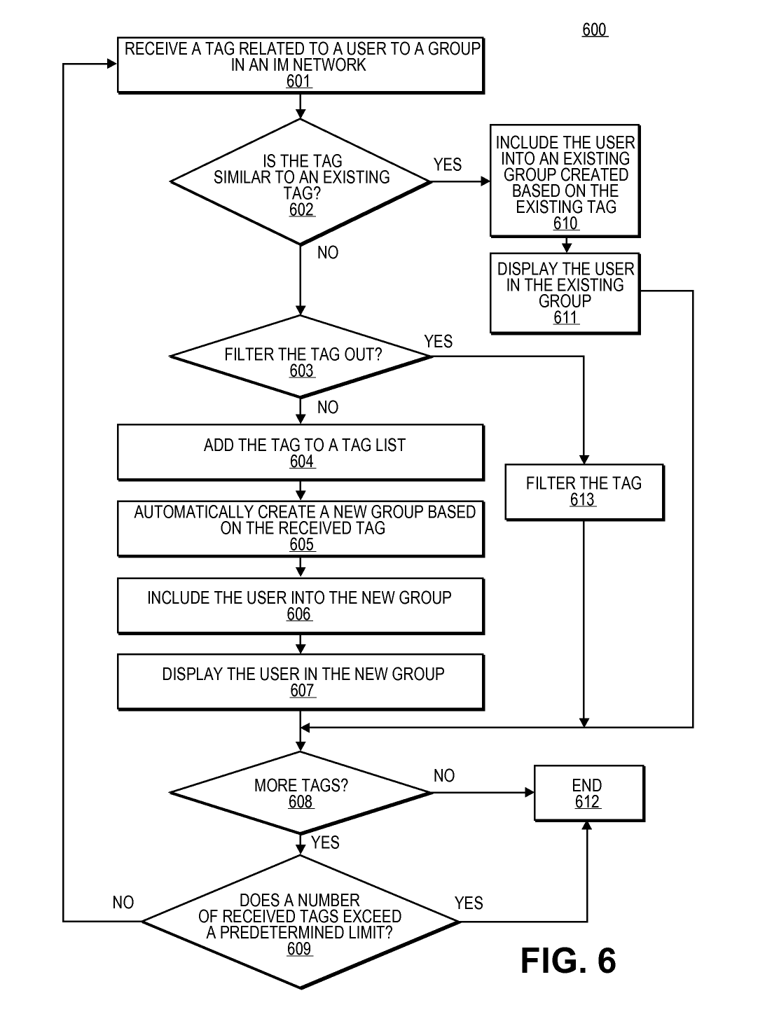

FIG. 6 is a flowchart of one embodiment of a method 600 to organize groups based on tags that may be performed at a client device. Method 600 begins with operation 601 involving receiving a tag associated with a user in an IM network. At operation 602 it is determined whether the received tag is similar to an existing tag. If the tag is similar to the existing tag, at operation 610, a user is included into an existing group created based on the existing tag. For example, if it is determined that the received tag “Carpool” is similar to the existing tag “Commuter”, people tagged with these tags may be grouped together. For another example, a user associated with the received tag “Opera Enthusiast” may be included into existing group “Opera”. In one embodiment, the tag's name may be adjusted to the existing tag's name. For example, tag “ichat” may be corrected to be “iChat”, and/or the misspelled tag's name may be adjusted to correct the typographical error.

At operation 611 the user is displayed in the existing group, and then method 600 goes to operation 608. If the received tag is not similar to the existing tag, it is determined at operation 603 (optionally) whether the received tag needs to be filtered out. If the tag needs to be filtered out, tag is filtered out at operation 613, so that the group associated with tag is not created. As shown in FIG. 5A, tag “Opera” is filtered out by Mike's device, so that the group associated with this tag is not created.

If the received tag does not need to be filtered out, the received tag is added to a tag list at operation 604. Next, at operation 605, a new group is created based on the received tag. At operation 606 the user is included into the new group. At operation 607 the user is displayed in the new group on a display. At operation 608 it is determined are there more tags. If there are no more tags, method 600 ends at 612. If there are more tags, at operation 609 it is determined whether a number of received tags exceed a predetermined limit. If the number of received tags does not exceed the predetermined limit, method 600 continues at operation 601. If the number of received tags exceeds the predetermined limit, new groups are not organized, and method 600 ends at 612.

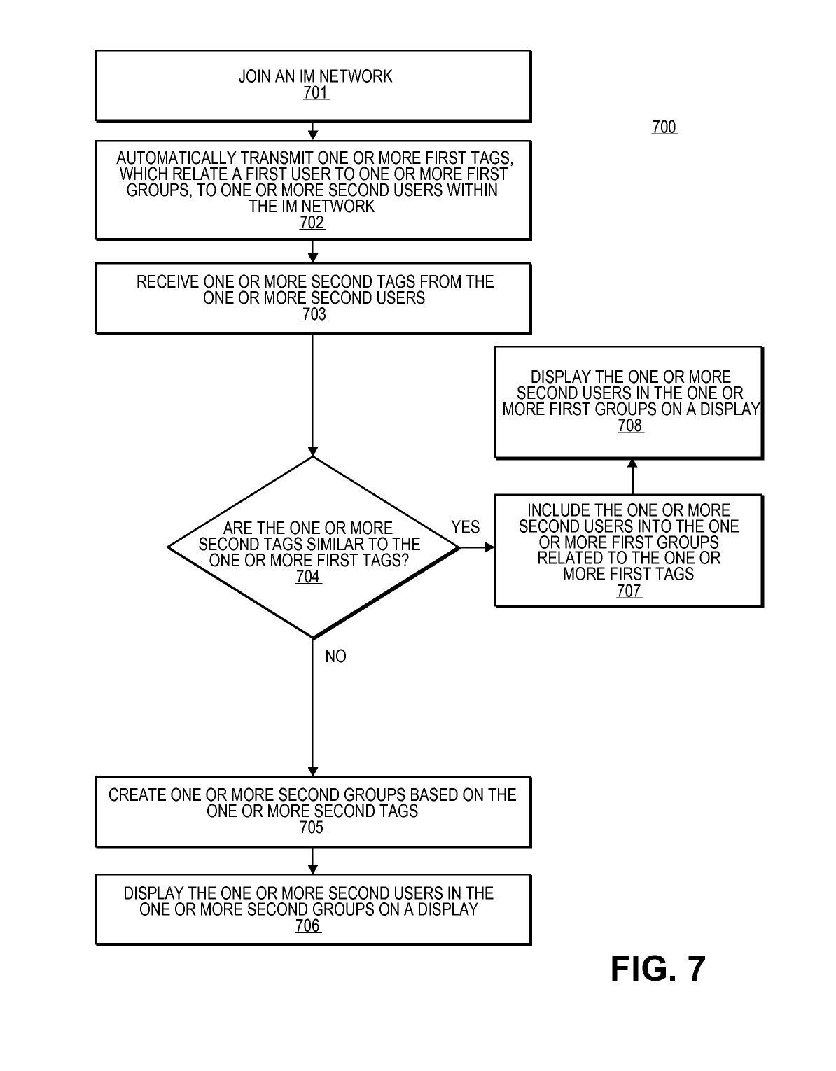

FIG. 7 is a flowchart of another embodiment of a method 700 to automatically organize groups based on tags that may be performed at a client device. Method begins with operation 701 that involves joining an IM network. At operation 702, in response to joining the IM network, one or more first tags, which relate a user to one or more first groups, are automatically transmitted to one or more second users in the IM network. At operation 703 one or more second tags are received from one or more second users in the IM network.

In one embodiment, the one or more first tags are transmitted from the user to one or more second users based on the received tags. For example, the first user may send out the tags only to those users on the IM network who have the tags, which are similar to the tags of the first user. In one embodiment, the user does not appear at all to other users in the network unless the user has a common group with the other users. In other words, the user can set a way how other users see him in the network (e.g., privacy settings).

At operation 704 it is determined whether the received one or more second tags are similar to the one or more first tags transmitted by the user. If the received second tags are similar to the first tags, at operation 707 the one or more second users are included into the one or more first groups related to the one or more first tags. At operation 708 the one or more second users are displayed in the one or more first groups on a display. If the received second tags are not similar to the one or more first tags, at operation 705 one or more second groups are created based on the one or more second tags. At operation 706 the one or more second users are displayed in the one or more second groups on a display.

In one embodiment, a user interface (UI) to manage user's tags is provided. The UI allows a user to add a tag that is in the user's list of buddies, and/or create a new tag. In at least some embodiments, a user can browse all the available tags on the network not just the ones that he sees in his buddy list. FIG. 5B illustrates one embodiment 550 of a user interface 538 having buddy groups organized based on tags. User interface 538 may display a user name (e.g., “John”), a status indicator 539 (e.g., “available”, “Away”, etc.), a switch identity 537, a tags' list 527, and groups 528-529 of users organized based on the tags. Tags' list 527 displays the tags (1^{st}, . . . i^{th}) assigned to the user, as described above. The user may edit tags through the tags' list 527. In another embodiment, a drop-down menu (not shown) is placed on top of a buddy list that displays the groups that the user is in and/or the tags that the user assigned to himself that the user can edit.

As shown in FIG. 5B, a group 528 of users is organized based on the first tag, a group 529 is organized based on i^{th} tag, as described above. In one embodiment, a dialog box (not shown) may open in response to a user's selection of a group, e.g., group 528, that offers the user to join this group or leave this group. In one embodiment, a tag and/or a field may be added to a presence data structure. In one embodiment, the presence info/node may read as follows:

<presence

host = “jsmith@jeono” status= “Available”
first = “John”
last = “Smith”
status=”available”
tags = “iChat”, “Commuters”, “Opera”, ...

FIG. 5C illustrates one embodiment of a user interface 560 to assign tags. In one embodiment, user interface 560 includes an account set up interface. User interface 560 may include screen name entry 561 to enter the user's screen name; password entries 562 and 563 to enter the password and re-enter the password respectively. User interface 560 includes tags item 564. In one embodiment, a drop-down tags menu 564 is opened in response to a user's selection of tags item 564. Drop-down tags' menu includes options to create a new tag and/or to open an existing tag to assign to the user. User may assign to himself one or more tags, as set forth above, and then press submit button 566 to confirm the tag's assignment, or press cancel button 567 to cancel the tag's assignment.

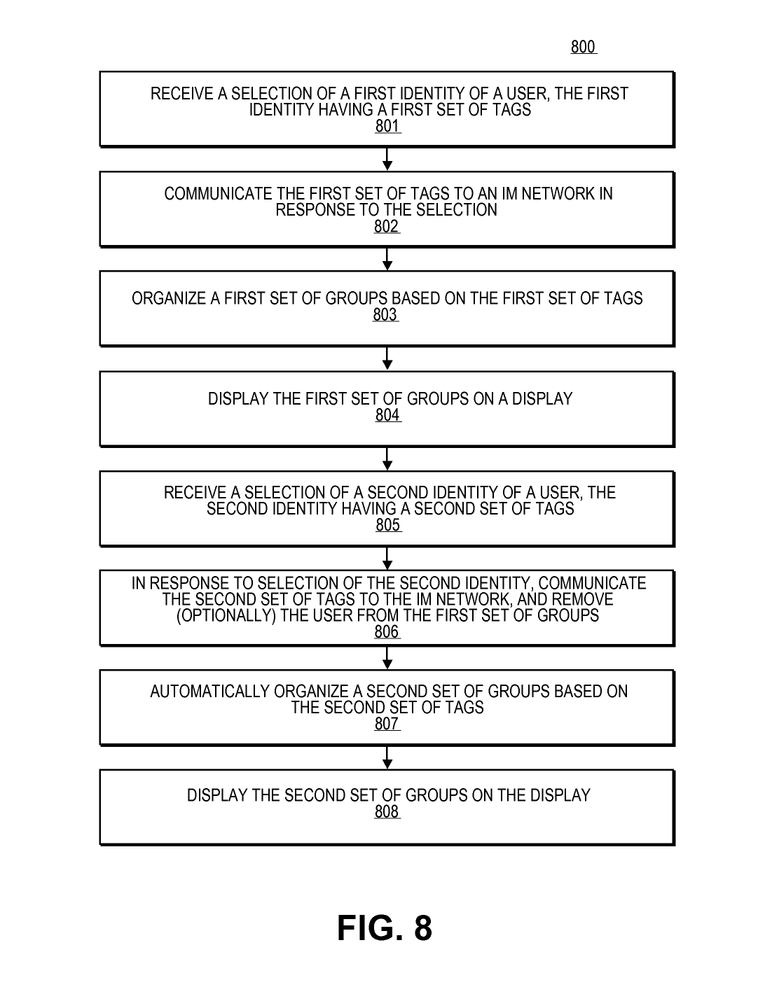

FIG. 8 is a flow chart of another embodiment a method to organize groups based on a user identity. Method begins with operation 801 that involves receiving a selection of a first identity of a user, the first identity having a first set of tags. More specifically, multiple set of tags may be assigned to multiple identities of a user. For example, a user may assign him self with a first set of tags associated with a work identity, and a second set of tags associated a public identity. These multiple identities may be provided through separate accounts. In at least some embodiments, the identity of the user includes one or more characteristics (“identity settings”). The identity settings may include, for example, a buddy picture, accounts to use, status messages, one or more tags, preference settings, and the like. In one embodiment, the identity of a user is switched by the operating system automatically depending on location of the user. For example, the identity switching can be performed based on an IP address and/or sub network the user is currently in. For another example, in case of iPhone/iPod Touch, the identity switching can be performed based on triangulation data from Global Positioning System (GPS) or cell towers. In one embodiment, all the applications subscribe to location changes and start to apply a new set of identity settings corresponding to a new location of the user. In one embodiment, the identity may be automatically switched by an operating system, e.g., Mac OS X. In one embodiment, the identity may be automatically switched by an application, e.g., iChat. In another embodiment, the identity may be switched in response to receiving a user input. For example, the user may switch between identities by pressing a switch identity 554. That is, the user may have multiple identities each with their associated sets of characteristics (e.g., tags) that the user can log in and out of. Method continues with operation 802 that involves communicating a first set of tags to an IM network, the first set of tags is associated with a first identity of a user. At operation 803 a first set of groups are organized based on the first set of tags. The first set of groups associated with the first identity of the user are displayed on a display at operation 804. At operation 805, a selection of a second identity is received from the user. At operation 806 a second set of tags associated with the second identity is communicated to the IM network in response to the selection. In one embodiment, the user may be removed from one or more groups associated with the first set of tags while the second set of tags is communicated to the IM network. At operation 807, a second set of groups is organized based on the second set of tags. At operation 808 the second set of groups are displayed on the display.

In one embodiment, a user can start a chat with the people who are in the same group at this moment. In another embodiment, a user can join a chat room that is populated automatically by everybody who's tagged themselves to be in the same group. In one embodiment, when a user logs-in to the IM network, the user joins one or more chat rooms based on the tags automatically and receives notification from other people in these chat rooms that are associated with the same tags. For example, when a person logs in to a public library IM network, the user does not need to address a specific person, the user can just open the library chat room and send an instant message to people from the same chat room.

In the foregoing specification, embodiments of the invention have been described with reference to specific exemplary embodiments thereof. It will be evident that various modifications may be made thereto without departing from the broader spirit and scope of the invention. The specification and drawings are, accordingly, to be regarded in an illustrative sense rather than a restrictive sense.

What is claimed is:

1. A machine-implemented method, comprising:
determining one or more first tags associated with a user on an instant messaging (IN) network; and
organizing one or more first groups based on the one or more first tags.

2. The machine-implemented method of claim 1, further comprising:
communicating the one or more first tags to the IM network.

3. The machine-implemented method of claim 1, wherein the organizing includes
creating the one or more first groups based on the one or more first tags.

4. The machine-implemented method of claim 1, wherein the organizing includes
including the user into the one or more first groups.

5. The machine-implemented method of claim 1, further comprising:
displaying the one or more first groups on a display.

6. The machine-implemented method of claim 1, wherein the determining includes
assigning the one or more first tags to the user.

7. The machine-implemented method of claim 1, further comprising:
receiving one or more second tags from one or more second users on the IM network; and
including the one or more second users into the one or more first groups if the one or more second tags are similar to the one or more first tags; and
creating one or more second groups based on the one or more second tags if the one or more second tags are not similar to the one or more first tags.

8. A machine-implemented method, comprising
receiving one or more tags associated with a user on an instant messaging network; and
organizing one or more groups based on the one or more tags.

9. The machine-implemented method of claim 8, wherein the organizing comprises
including the user into the one or more groups.

10. The machine-implemented method of claim 8, wherein the organizing comprises:
creating the one or more groups based on the one or more tags.

11. The machine-implemented method of claim 8, further comprising:
determining whether the one or more tags is similar to an existing tag.

12. The machine-implemented method of claim 8, further comprising:
determining whether the one or more tags needs to be filtered.

13. A machine-implemented method, comprising:
communicating a first set of tags to an instant messaging (IM) network, the first set of tags is associated with a first identity of a user;
receiving a selection of a second identity of the user; and
communicating a second set of tags to the IM network in response to the selection.

14. The machine-implemented method of claim 13, further comprising:
removing the user from one or more groups associated with the first set of tags.

15. The machine-implemented method of claim 13, further comprising:
organizing a second set of groups based on the second set of tags.

16. The machine-implemented method of claim 15, further comprising:
displaying the second set of groups on a display.

17. The machine-implemented method of claim 13, further comprising:
organizing a first set of groups based on the first set of tags.

18. A machine-readable medium storing executable program instructions which cause a data processing system to perform operations comprising:
determining one or more first tags associated with a user on an instant messaging (IM) network; and
organizing one or more first groups based on the one or more first tags.

19. The machine-readable medium of claim 18, further including data that cause the data processing system to perform operations comprising communicating the one or more first tags to the IM network.

20. The machine-readable medium of claim 18, wherein the organizing includes creating the one or more first groups based on the one or more first tags.

21. The machine-readable medium of claim 18, wherein the organizing includes including the user into the one or more first groups.

22. The machine-readable medium of claim 18, further including data that cause the data processing system to perform operations comprising:
displaying the one or more first groups on a display.

23. The machine-readable medium of claim 18, wherein the determining includes
assigning the one or more first tags to the user.

24. The machine-readable medium of claim 18, further including data that cause the data processing system to perform operations comprising:
receiving one or more second tags from one or more second users on the IM network;
including the one or more second users into the one or more first groups if the one or more second tags are similar to the one or more first tags; and
creating one or more second groups based on the one or more second tags if the one or more second tags are not similar to the one or more first tags.

25. A machine-readable medium storing executable program instructions which cause a data processing system to perform operations comprising:
receiving one or more tags associated with a user on an instant messaging network; and
organizing one or more groups based on the one or more tags.

26. The machine-readable medium of claim 25, wherein the organizing comprises:
including the user into the one or more groups.

27. The machine-readable medium of claim 25, wherein the organizing comprises:
creating the one or more groups based on the one or more tags.

28. The machine-readable medium of claim 25, further including data that cause the data processing system to perform operations comprising:
determining whether the one or more tags is similar to an existing tag.

29. The machine-readable medium of claim 25, further including data that cause the data processing system to perform operations comprising:
determining whether the one or more tags needs to be filtered.

30. A machine-readable medium storing executable program instructions which cause a data processing system to perform operations comprising:
communicating a first set of tags to an instant messaging (IM) network, the first set of tags is associated with a first identity of a user;
receiving a selection of a second identity of the user; and
communicating a second set of tags to the IM network in response to the selection.

31. The machine-readable medium of claim 30, further including data that cause the data processing system to perform operations comprising:
removing the user from one or more groups associated with the first set of tags.

32. The machine-readable medium of claim 30, further including data that cause the data processing system to perform operations comprising:
organizing a second set of groups based on the second set of tags.

33. The machine-implemented method of claim 32, further including data that cause the data processing system to perform operations comprising:
displaying the second set of groups on a display.

34. The machine-readable medium of claim 30, further including data that cause the data processing system to perform operations comprising:
organizing a first set of groups based on the first set of tags.

35. A data processing system, comprising:
a processor, and a memory coupled to the processor, wherein the processor is configured to determine one or more first tags associated with a user on an instant messaging (IM) network; and to organize one or more first groups based on the one or more first tags.

36. The data processing system of claim 35, wherein the processor is further configured to communicate the one or more first tags to the IM network.

37. The data processing system of claim 35, wherein the organizing includes
creating the one or more first groups based on the one or more first tags.

38. The data processing system of claim 35, wherein the organizing includes
including the user into the one or more first groups.

39. The data processing system of claim 35, wherein the processor is further configured to display the one or more first groups on a display.

40. The data processing system of claim 35, wherein the determining includes
assigning the one or more first tags to the user.

41. The data processing system of claim 35, wherein the processor is further configured to
receive one or more second tags from one or more second users on the IM network;
include the one or more second users into the one or more first groups if the one or more second tags are similar to the one or more first tags; and
create one or more second groups based on the one or more second tags if the one or more second tags are not similar to the one or more first tags.

42. A data processing system, comprising:
a processor, and
a memory coupled to the processor, wherein the processor is configured to receive one or more tags associated with a user on an instant messaging network; and to organize one or more groups based on the one or more tags.

43. The data processing system of claim 42, wherein the organizing comprises
including the user into the one or more groups.

44. The data processing system of claim 42, wherein the organizing comprises:
creating the one or more groups based on the one or more tags.

45. The data processing system of claim 42, wherein the processor is further configured to
determine whether the one or more tags is similar to an existing tag.

46. The data processing system of claim 42, wherein the processor is further configured to
determine whether the one or more tags needs to be filtered.

47. A data processing system, comprising:
a processor, and
a memory, coupled to the processor, wherein the processor is configured to communicate a first set of tags to an instant messaging (IM) network, the first set of tags is associated with a first identity of a user; to receive a selection of a second identity of the user;
and to communicate a second set of tags to the IM network in response to the selection.

48. The data processing system of claim 47, wherein the processor is further configured to remove the user from one or more groups associated with the first set of tags.

49. The data processing system of claim 47, wherein the processor is further configured to
organize a second set of groups based on the second set of tags.

50. The data processing system of claim 49, wherein the processor is further configured to
display the second set of groups on a display.

51. The data processing system of claim 47, wherein the processor is further configured to
organize a first set of groups based on the first set of tags.

52. A data processing system, comprising:
means for determining one or more first tags associated with a user on an instant messaging (IM) network; and
means for organizing one or more first groups based on the one or more first tags.

53. A data processing system, comprising:
means for receiving one or more tags associated with a user on an instant messaging network; and
means for organizing one or more groups based on the one or more tags.

54. A data processing system, comprising:
means for communicating a first set of tags to an instant messaging (IM) network, the first set of tags is associated with a first identity of a user;
means for receiving a selection of a second identity of the user; and
means for communicating a second set of tags to the IM network in response to the selection.
